(19) United States
(12) Patent Application Publication
(10) Pub. No.: US 2026/0110604 A1
(43) Pub. Date: Apr. 23, 2026

(54) SOLID PHASE EXTRACTION DEVICE AND METHOD FOR FILTRATION AND ANALAYTE ISOLATION IN LIQUID SAMPLES

(71) Applicant: OBOTICS, LLC, Weston, FL (US)

(72) Inventor: LANE YAGO, VIRGINIA BEACH, VA (US)

(21) Appl. No.: 18/987,777

(22) Filed: Dec. 19, 2024

Related U.S. Application Data
(63) Continuation-in-part of application No. 18/236,822, filed on Aug. 22, 2023.
(60) Provisional application No. 63/399,725, filed on Aug. 22, 2022.

(51) Int. Cl. G01N 1/34; B01L 3/00

(52) U.S. Cl. CPC G01N 1/34; B01L 3/502753; B01L 2300/0681; B01L 2300/0832

(57) ABSTRACT

A sample tube filtration system for isolating analytes of interest from a liquid sample containing suspended particulate matter is disclosed. The system includes a sample tube filter assembly with an upper body and a lower body interconnected to hold a support structure. The support structure comprises solid phase extraction (SPE) material chemically bonded to either a wire mesh or a tubular body, where the SPE material is bonded to both inner and outer surfaces to maximize adsorption surface area. A pipette tip engagement assembly allows the filter assembly to operatively engage a disposable pipette tip, enabling repeated plunging motions through the liquid sample. This facilitates simultaneous particulate filtration and selective adsorption of analytes onto the SPE material. The system is further configured for washing to remove interferences and for releasing the captured analytes into a small solvent volume, providing an efficient, reliable, and cost-effective solution for sample preparation workflows.

### CLAIM OF PRIORITY

This application is a Continuation-in-Part of U.S. Non-Provisional patent application Ser. No. 18/236,822 , filed on Aug. 22, 2023, which in turn claims the benefit of U.S. Provisional Patent Application Ser. No. 63/399,725 filed on Aug. 22, 2022, both of which are incorporated by reference herein in their entireties.

### BACKGROUND OF THE INVENTION

### Field of the Invention

The present invention relates generally to filtration devices and methods for processing liquid samples. More specifically, the invention pertains to a device and method that combine solid phase extraction (SPE) and mechanical filtration techniques. The device integrates a chemically bonded SPE material onto a wire mesh structure and is operable by a pipette tip for isolating analytes of interest from liquid samples. The invention is particularly suited for efficient analyte capture and concentration in various chemical, biological, and analytical processes.

### Description of the Related Art

The practice of sampling liquids for analysis, filtration, or separation purposes has long been a cornerstone of scientific and industrial workflows. This process typically requires the extraction of measured liquid volumes from larger samples, often containing impurities, suspended particulate matter, or dissolved compounds of interest. Accurately separating the liquid phase from undesired materials while isolating specific analytes has become increasingly critical across fields such as clinical diagnostics, environmental monitoring, pharmaceutical research, and chemical analysis.

Historically, liquid handling began with rudimentary tools such as elongated glass pipettes. These devices relied on manual operation, wherein a user manipulated the pipette to draw a measured quantity of liquid into the tube. By squeezing and releasing an attached bulb, a vacuum was created, pulling liquid into the device for subsequent transfer. While functional, these early methods were highly susceptible to operator variability and contamination due to repeated use and required thorough cleaning between samples.

The advent of disposable pipette tips marked a significant advancement in liquid sampling. By affixing a sterile, single-use plastic tip to the end of a pipette, contamination between samples could be largely mitigated. This innovation improved the precision and reliability of pipetting, particularly for applications involving biological samples or hazardous chemicals. As sampling processes became more standardized, manual pipetting devices evolved to incorporate plungers and precision-calibrated mechanisms capable of aspirating and dispensing precise liquid volumes.

With growing demands for speed, accuracy, and throughput, automated liquid handling systems emerged to address the limitations of manual sampling. These devices, often controlled by sophisticated robotics, are capable of processing thousands of samples in a single run. Equipped with arrays of disposable pipette tips, automated systems can draw and dispense liquids from sample tubes with unparalleled consistency. Such technologies are indispensable in modern laboratories, where high-throughput workflows are essential for tasks like chemical screening, genetic analysis, and quality control testing.

Despite these advancements, liquid sampling processes face recurring challenges stemming from the presence of suspended particulate matter within the sample. Solid particulates, cellular debris, or undissolved compounds in the liquid phase can interfere with downstream analysis or block sampling equipment. For example, disposable pipette tips are prone to clogging when exposed to particulates, leading to sampling errors, incomplete transfers, and costly disruptions in laboratory workflows. In automated systems, these interruptions can compromise efficiency and require recalibration, replacement of tips, or manual intervention to restore operation.

To mitigate these issues, centrifugation is frequently employed as a preparatory step prior to liquid sampling. Centrifugal force drives suspended particles to the bottom of sample tubes, allowing for the extraction of relatively clean supernatant from the upper portion of the liquid. While effective, centrifugation introduces its own challenges. The process requires additional equipment, often expensive and complex, particularly when integrated with automated liquid handling systems. Laboratory centrifuges can cost tens of thousands of dollars, with additional expenses incurred for software integration, maintenance, and operator training.

Manual centrifugation, while less costly upfront, demands significant labor and time to process sample tubes individually. For laboratories managing high sample volumes, these delays accumulate into substantial inefficiencies. Furthermore, repeated handling of samples increases the risk of cross-contamination, spillage, and operator error, undermining the accuracy and reliability of the results. For smaller facilities with limited budgets, the costs associated with centrifugation equipment, operation, and time can be prohibitive, restricting access to streamlined workflows.

In addition to physical particulates, liquid samples often contain dissolved compounds or analytes that require separation or concentration prior to analysis. Solid Phase Extraction (SPE) techniques have been widely adopted to address this need. SPE involves the use of specialized materials, such as silica-based sorbents, which selectively retain target compounds as the liquid sample passes through. The process relies on pressure or vacuum systems to move liquid through SPE cartridges or packed columns, enabling chemical separation of analytes from interfering substances. Once retained, the analytes are typically washed with solvents to remove contaminants and subsequently eluted for analysis.

While SPE has proven effective, traditional methods often require specialized equipment and infrastructure. Vacuum manifolds, pressure pumps, and complex tubing systems are commonly employed to facilitate liquid movement through SPE materials. These setups introduce additional costs, space requirements, and operational complexities. Furthermore, the need for external pressure systems can limit the portability and flexibility of SPE workflows, particularly in field applications or resource-constrained environments.

The combination of physical filtration and chemical separation presents further challenges in conventional workflows. Physical filtration devices, such as membranes or filter discs, are effective for removing particulates but do not address the isolation of dissolved analytes. Conversely, SPE systems excel at chemical separation but are less effective for handling suspended solids. In workflows where both particulate removal and analyte isolation are required, laboratories often resort to sequential processes involving multiple devices, increasing complexity, time, and the potential for sample loss or contamination.

Another limitation in existing systems lies in the handling of small sample volumes. Many modern applications, such as molecular diagnostics or trace chemical analysis, require highly concentrated samples to achieve reliable results. Traditional filtration and SPE methods often involve significant sample dilution, as large liquid volumes are passed through the separation medium. This can reduce analyte concentrations to levels that are difficult to detect or quantify, necessitating additional steps to re-concentrate the sample.

The inefficiencies in current methods are compounded by the growing demand for faster, more cost-effective sample preparation solutions. Laboratories are under constant pressure to improve throughput, reduce turnaround times, and minimize operational costs. Disposable consumables, such as pipette tips and filtration membranes, contribute significantly to recurring expenses, particularly in high-volume settings. Additionally, the environmental impact of single-use plastics has become a growing concern, driving efforts to develop more sustainable alternatives without compromising performance.

In light of these challenges, there remains a need for improved sample processing methods that streamline physical filtration, chemical separation, and analyte concentration into a single, efficient workflow. Such methods must minimize the need for additional equipment, reduce operational costs, and be adaptable to both manual and automated systems. Furthermore, solutions capable of handling small sample volumes without significant dilution would address critical gaps in applications requiring high sensitivity and accuracy.

Efforts to address these shortcomings have focused on integrating filtration and SPE techniques into compact, user-friendly devices. By combining the principles of mechanical filtration and chemical adsorption, these approaches aim to simplify workflows, improve analyte recovery, and reduce sample handling steps. Key considerations include the selection of filtration materials, the design of support structures for SPE media, and the compatibility of these devices with existing liquid handling equipment, such as pipettes.

Advancements in materials science have further expanded the possibilities for improved filtration and separation technologies. For instance, wire mesh supports, engineered with precise pore sizes and surface coatings, offer a robust and customizable platform for integrating filtration and SPE functionalities. Chemically modified surfaces can selectively bind target compounds, enabling efficient analyte isolation without the need for external pressure systems. Additionally, resilient materials, such as silicone or polymeric membranes, can be incorporated to create seals that prevent bypass flow and ensure uniform liquid movement through the separation medium.

The demand for innovative solutions that address both particulate removal and analyte isolation continues to grow across scientific and industrial sectors. As laboratories strive to optimize efficiency, reduce costs, and improve analytical outcomes, there remains a pressing need for technologies that overcome the limitations of existing methods. Such advancements hold the potential to transform sample preparation workflows, enabling more accurate, reliable, and scalable analysis of liquid samples in diverse applications.

### SUMMARY OF THE INVENTION

The present invention relates to a solid phase extraction (SPE) and filtration device designed for efficient analyte isolation and particulate removal from liquid samples. The device includes a robust support structure, such as a wire mesh, with a chemically bonded SPE material that enables selective adsorption of target analytes while allowing liquid to pass through. The device is operable with a pipette tip, which facilitates precise movement of the SPE material through the liquid sample. By employing a repeated plunging motion within the sample tube, the device traps analytes of interest on its surface while effectively separating unwanted particulates. The invention streamlines analyte capture, washing, and release processes without relying on external pressure or vacuum systems, enabling rapid and efficient sample preparation for downstream analysis.

The present invention addresses several shortcomings of the prior art by combining physical filtration and chemical separation into a single, integrated device. Unlike traditional SPE systems, which require external pressure or vacuum equipment to move liquid through the separation medium, the present invention simplifies this process by actively moving the SPE material through the sample. This eliminates the need for complex infrastructure, reduces operational costs, and minimizes sample handling. Additionally, the device's ability to capture target analytes through repeated plunging motions allows for efficient extraction even in small sample volumes, ensuring high analyte recovery without significant dilution. The device is further designed to seamlessly interface with standard pipette systems, making it versatile for both manual and automated workflows, while enhancing throughput, reducing contamination risks, and improving overall laboratory efficiency.

In a first implementation of the present invention, a sample tube filtration system is provided for isolating analytes of interest from a liquid sample containing suspended particulate matter. The system includes a filter assembly having an upper body and a lower body interconnected to hold a wire mesh support structure. The wire mesh support structure features a chemically bonded solid phase extraction (SPE) material that selectively adsorbs analytes while allowing liquid to pass through. The system further comprises a pipette tip engagement assembly configured to mount the filter assembly onto a disposable pipette tip, enabling the filter assembly to be pushed downward and repeatedly moved within the liquid sample for effective analyte isolation. In another aspect, the wire mesh support structure comprises a plurality of openings configured to allow liquid flow while supporting the solid phase extraction (SPE) material.

In another aspect, the SPE material is chemically bonded to the wire mesh support structure and is selected to selectively retain analytes of predetermined chemical properties.

In another aspect, the sample tube filter assembly includes a tubular body having an inner surface and an outer surface, wherein the SPE material is bonded to both the inner surface and the outer surface to maximize available surface area.

In another aspect, the tubular body includes an upper attachment section configured to engage a portion of the disposable pipette tip for operation within the liquid sample.

In another aspect, the tubular body comprises a diameter sized for insertion into a small sample tube or well.

In another aspect, the tubular body has a length configured to increase the surface area available for bonding of the SPE material, thereby increasing the capacity to adsorb analytes of interest.

In another aspect, the upper body and the lower body are interconnected to enclose the wire mesh support structure in a manner that secures the SPE material in position.

In another aspect, the pipette tip engagement assembly includes an upper engagement channel formed through a portion of the upper body and a lower engagement channel formed through a portion of the lower body.

In another aspect, the upper engagement channel and the lower engagement channel are disposed coaxially with one another.

In another aspect, the wire mesh support structure is constructed from stainless steel.

In another aspect, the tubular body is constructed from stainless steel.

In another aspect, the SPE material comprises a chemically modified surface configured to selectively adsorb analytes of interest from the liquid sample.

In another aspect, the sample tube filter assembly is configured to allow repeated movement through the liquid sample to enhance adsorption of analytes onto the SPE material.

In another aspect, the system further comprises a wiper assembly disposed around at least one of the upper body, the lower body, or the tubular body, said wiper assembly being configured to engage an inner wall of the sample tube or well to minimize bypass of the liquid sample.

In another aspect, the wiper assembly comprises a resilient material.

In another aspect, the wiper assembly includes a central slit configured to allow passage of a portion of the disposable pipette tip while maintaining engagement with the inner wall of the sample tube.

In another aspect, the SPE material is configured to release the adsorbed analytes into a solvent upon contact with the solvent.

In another aspect, the system is configured to enable washing of the SPE material with a solvent to remove interferences while retaining analytes of interest.

In another implementation of the present invention, a sample tube filtration system is provided for isolating analytes of interest from a liquid sample in a small sample tube or well. The system includes a tubular body having a length and a diameter sized for insertion into the small sample tube or well, wherein the tubular body comprises an inner surface and an outer surface with a solid phase extraction (SPE) material chemically bonded to both surfaces to maximize available surface area. The tubular body further includes an upper attachment section configured to engage a portion of a disposable pipette tip for operation within the liquid sample. A wiper assembly, formed of a resilient material, is disposed around the tubular body to engage the inner wall of the small sample tube or well, minimizing bypass of the liquid sample. The tubular body is configured to allow repeated plunging motions through the liquid sample to enhance adsorption of analytes onto the SPE material, and the SPE material is further configured to selectively release the adsorbed analytes into a solvent upon contact with the solvent for downstream analysis.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an exploded perspective view of one illustrative embodiment of a sample tube filter assembly, in accordance with the present invention;

FIG. 2 presents a perspective view of the sample tube filter assembly of FIG. 1 in an assembled configuration, in accordance with the present invention;

FIG. 3 presents a perspective view of a wiper assembly as a part of the sample filter tube assembly of FIG. 1, in accordance with the present invention;

FIG. 4A presents a perspective view of a filter top of the sample tube filter assembly of FIG. 1, having a checkered aperture design in accordance with the present invention;

FIG. 4B presents a perspective view of a filter top of the sample tube filter assembly of FIG. 1, having a spoked aperture design in accordance with the present invention;

FIG. 5 presents a perspective view of the sample tube filter assembly of FIG. 2 operatively mounted to a portion of a disposable pipette tip attached to a pipette, in accordance with the present invention;

FIGS. 6A through 6C present elevations of one illustrative embodiment of filtering a liquid sample in a sample tube with a sample tube filtration system and obtaining a liquid sample therefrom, in accordance with the present invention;

FIG. 7A through 7D present elevations of one alternative illustrative embodiment of filtering a liquid sample in a sample tube with a sample tube filtration system and obtaining a liquid sample therefrom, in accordance with the present invention;

FIG. 8 presents a cross-sectional view of one illustrative embodiment of a sample tube filter assembly operatively mounted to a portion of a disposable pipette tip attached to a pipette inserted into a sample tube, in accordance with the present invention;

FIG. 9 presents an enlarged cross-sectional view of the sample tube filter assembly of FIG. 8 operatively mounted to the portion of the disposable pipette tip attached to the pipette inserted into the sample tube, in accordance with the present invention;

FIG. 10 presents a diagrammatic representation of one illustrative embodiment of a method of filtering a liquid sample in a sample tube with a sample tube filtration system and obtaining a liquid sample therefrom, in accordance with the present invention;

FIG. 11 presents a diagrammatic representation of one alternative illustrative embodiment of a method of filtering a liquid sample in a sample tube with a sample tube filtration system and obtaining a liquid sample therefrom, in accordance with the present invention; and

FIG. 12 presents a top view of a wire mesh support structure comprising a grid-like mesh for liquid flow and SPE material support, reinforced by a cross-shaped frame for stability, with a central aperture for alignment with a pipette tip, in accordance with an alternate embodiment of the present invention.

Like reference numerals refer to like parts throughout the several views of the drawings.

### DETAILED DESCRIPTION OF THE PREFERRED EMBODIMENT

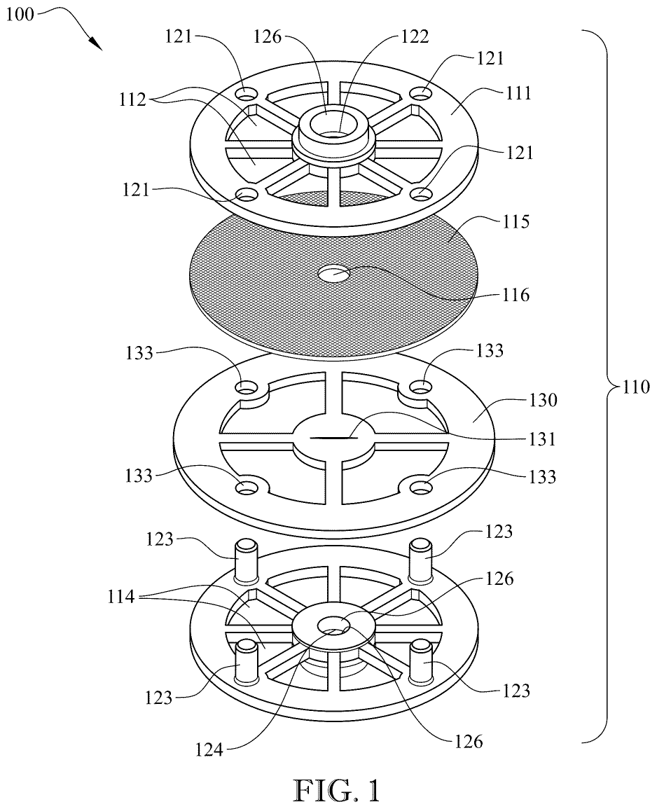

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed generally toward a sample tube filtration system and a method of filtering a liquid sample in a sample tube with a sample tube filtration system and obtaining a liquid sample therefrom.

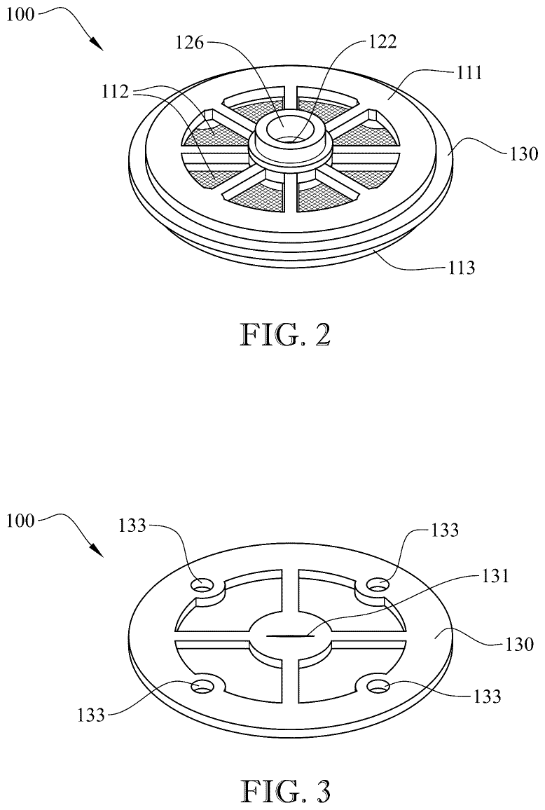

Referring initially to FIGS. 1 and 2, exploded and perspective views of one illustrative embodiment of a sample tube filtration system, generally shown as at 100 throughout the figures, are presented, respectively. A sample tube filtration system 100 in accordance with the present invention includes a sample tube filter assembly 110. In at least one embodiment, the sample tube filter assembly 110 comprises a filter top 111 and a filter bottom 113, as may be visualized in the illustrative embodiments of FIGS. 1 and 2. Each of the filter top 111 and the filter bottom 113 incorporates at least one filtration aperture. Notably, the filter top 111 possesses a plurality of upper filtration apertures 112, and the filter bottom 113 contains a plurality of lower filtration apertures 114. The plurality of lower filtration apertures 114 are designed to allow a quantity of a liquid sample with suspended particulate matter therein to move into the filter bottom 113. Concurrently, the upper filtration apertures 112 are structured to let a measure of filtered liquid sample, or filtrate, flow through for collection from the upper segment of a sample tube by a pipette equipped with a disposable pipette tip, as will be elaborated in subsequent sections. Both the upper filtration apertures 112 and the lower filtration apertures 114 exhibit an effective diameter ranging from approximately 0.1 millimeters to about 5 millimeters.

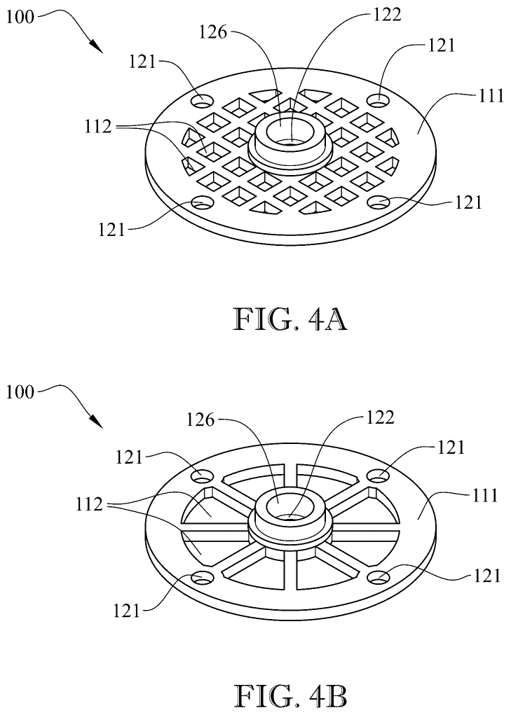

As depicted in FIG. 4A, one embodiment presents the filter top with a checkered aperture design. This grid-like design, reminiscent of a checkerboard, allows for uniform fluid flow through the equally spaced square-shaped apertures. This consistent flow ensures that particles are effectively captured and filtered, with minimal risk of clogging or bypass.

In contrast, FIG. 4B introduces a filter top with a spoked aperture design. Here, the filter top features triangular apertures, arranged in a pattern that radiates outward from a central point, much like the spokes of a wheel. This unique design facilitates a radial flow of fluid, directing it towards the center and then outward, enhancing the even distribution of the fluid over the filter surface. The triangular apertures, with their tapering design, provide a distinct advantage in optimizing the surface area for filtration while simultaneously reducing the chances of particles being trapped at the aperture corners. Both designs, while different in form, ensure effective filtration, offering flexibility in choice based on specific requirements and sample characteristics.

It should be understood that either the filter top 111 or the filter bottom 113, or even both, might feature a filtration aperture 112, 114 composed of a basic open ring structure. This is purposed to support a filter 115 placed in between, which is constructed to attach via four holes 121 on the filter top 111 and corresponding four posts 123 on the filter bottom 113, as detailed in the sections below.

Within this context, “suspended particulate matter” is inclusive of solid particulate components dispersed within a liquid sample. However, the term “suspended particulate matter” encompasses various other contaminants potentially present in a liquid sample. Examples encompass certain proteins, white blood cells, and distinct chemicals that could be associated with the specific material constituting a filter 115, among others.

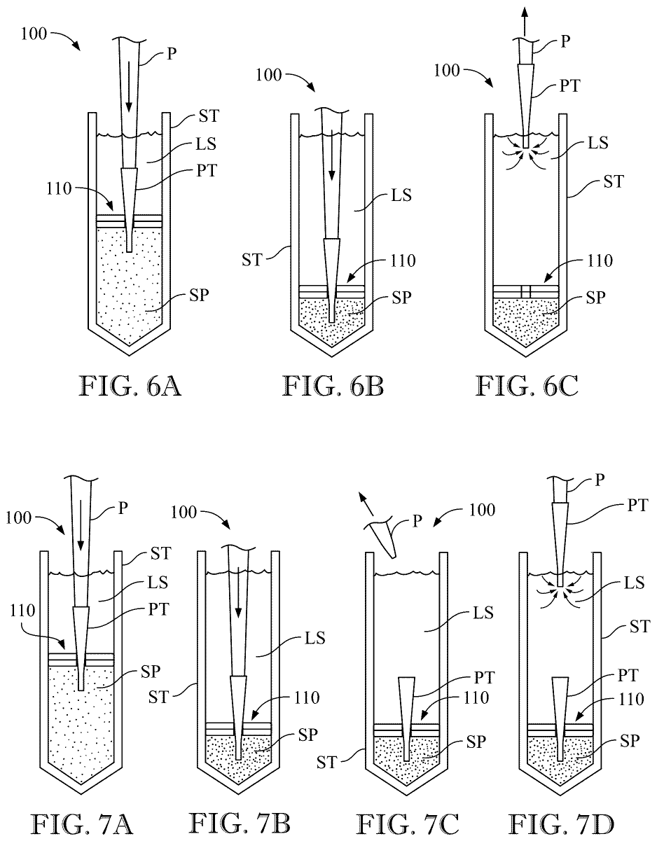

In one of the embodiments, the filter top 111 encompasses four holes and the filter bottom 113 includes four posts. These posts are tailored to engage with the holes on the filter top, piercing through the filter, thus forming the filter assembly. Referencing the depictions in FIGS. 6 and 7, the four posts on the filter bottom 113 are designed to seamlessly fit into the four holes of the filter top 111, ensuring a secure assembly.

Both the filter top 111 and the filter bottom 113, in line with this invention, can be fashioned from a plethora of rigid or semi-rigid materials. These can range from metals, metal alloys, plastics, thermoplastics, rubber, to fiberglass and more. In a specific embodiment, both the filter top 111 and the filter bottom 113 are molded from a thermoplastic material. The choice of material for the filter top 111 and filter bottom 113 can vary vastly, depending primarily on its compatibility with the biological or chemical nature of the liquid samples.

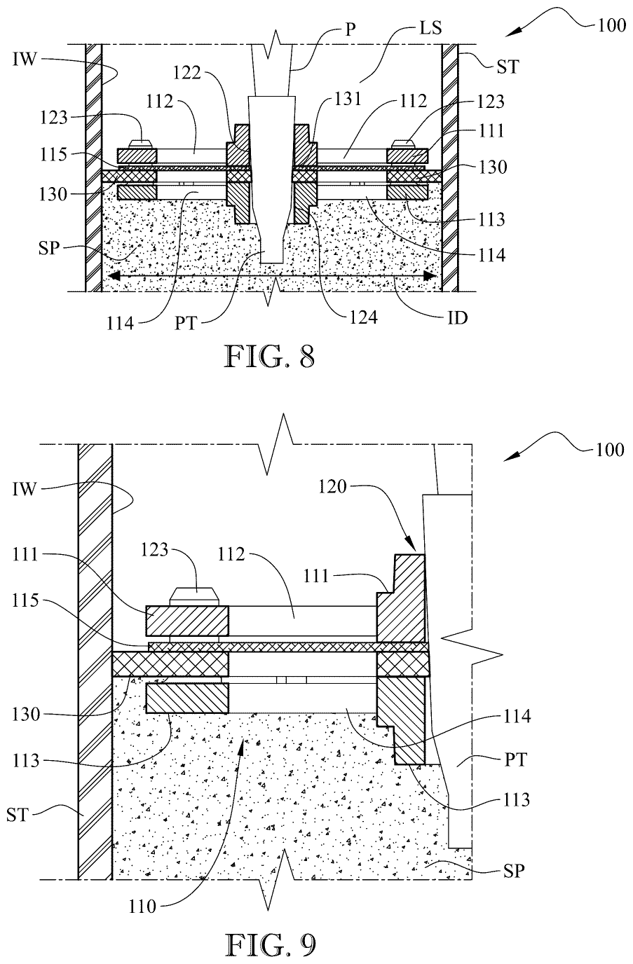

The sample tube filter assembly 110 integral to the present sample tube filtration system 100 additionally incorporates a filter 115. Positioned between the filter top 111 and the filter bottom 113, as best demonstrated in FIGS. 8 and 9, the filter 115 is composed of a material that prevents suspended particulate matter of a specific effective diameter in a liquid sample from passing through.

Recognizing the diversity in applications, the filter 115 might be composed of various materials fit for liquid filtration, such as cellulose, ashless paper, plastics, or plastic-coated paper, among others. The filter media selection can vary extensively, influenced by the biological or chemical properties of the liquid samples. The filter 115 can be hydrophilic, like water-wettable polytetrafluoroethylene or an acrylic polymer on a non-woven base, or hydrophobic, such as hydrophobic polytetrafluoroethylene. In one version, the filter 115 has a pore size designed to restrict suspended particulate matter of an effective diameter between 0.01 micrometers to 10 micrometers. As previously mentioned, “suspended particulate matter” can span from solid particles in a liquid sample to various other contaminants. In some variations, the filter 115 is composed of multiple filter media layers with differing pore sizes, where the layer with larger pores overlies the one with smaller pores.

A sample tube filtration system 100 in accordance with the present invention further comprises a pipette tip engagement assembly 120. In at least one embodiment, a pipette tip engagement assembly 120 includes an upper engagement channel 122 formed through a portion of the filter top 111, and a lower engagement channel 124 formed through a portion of the filter bottom 113, such as is shown best in FIG. 1. As may be seen from FIG. 1, each of an upper engagement channel 122 and a lower engagement channel 124 are formed centrally through an axis through a corresponding one of the filter top 111 and the filter bottom 113, respectively, such that the upper engagement channel 122 and the lower engagement channel 124 are disposed coaxial with one another while the filter top 111 and the filter bottom 113 are interconnected to one another, as seen best in the illustrative embodiment of FIG. 2. As further shown in FIG. 1, in at least one embodiment, a filter 115 includes a filter aperture 116 which is also disposed coaxially with the upper engagement channel 122 and the lower engagement channel 124,

It is to be appreciated, however, that in at least one embodiment, each of an upper engagement channel 122 and a lower engagement channel 124 may be formed offset from the axis through a corresponding one of the filter top 111 and the filter bottom 113, respectively. It is to be further appreciated that a pipette tip engagement assembly 120 in at least one embodiment may include a plurality of upper engagement channel channels 122 formed through the filter top 111 and a corresponding plurality of lower engagement channels 124 formed through the filter bottom 113.

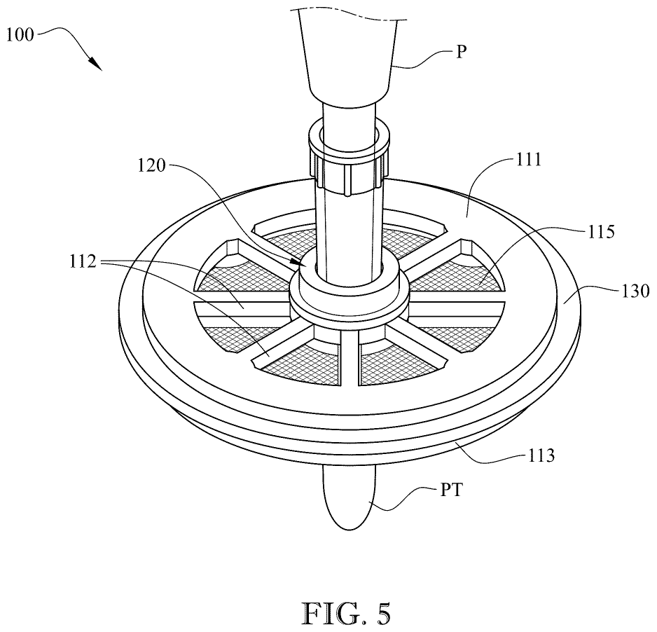

With reference once again to FIG. 8, in at least one embodiment each of an upper engagement channel 122 and a lower engagement channel 124 of a pipette tip engagement assembly 120 are dimensioned and configured to receive a portion of a disposable pipette tip at least partially therethrough. As may be seen from FIG. 5, in at least one embodiment, a pipette tip engagement assembly 120 is dimensioned and configured to operatively engage a portion of a disposable pipette tip DP attached to a pipette P so that a sample tube filter assembly 110 is mountable to a portion of the disposable pipette tip DP, such that the sample tube filter assembly 110 may be pushed downward through at least a portion of a liquid sample in the sample tube by the disposable pipette tip DP attached to the pipette P, as is discussed in greater detail below. As will be appreciated, a pipette tip engagement assembly 120 in accordance with the present invention may comprise any of a number of dimensions and configurations so as to accommodate any of the plurality of dimensions and configurations of disposable pipette tips with which the present invention may be utilized.

In at least one embodiment, a pipette tip engagement assembly 120 in at least one embodiment includes at least one engagement member 126 configured to operatively engage a portion of a disposable pipette tip positioned therethrough. In one further embodiment, a pipette tip engagement assembly 120 comprises a plurality of engagement members 126, each configured to operatively engage a portion of the disposable pipette tip positioned therethrough. With reference once again to FIGS. 1 and 2, the pipette tip engagement assembly 120 comprises a plurality of engagement members 126. More in particular, a plurality of engagement members 126 are provided in each of the upper engagement channel 122 and the lower engagement channel 124 of the pipette tip engagement assembly 120, as seen best in the illustrative embodiment of FIG. 1. As shown in the figures, an engagement member 126 in accordance with at least one embodiment of the present invention comprises a downwardly directed barb-like configuration, thus making it difficult, if not impossible, to remove a disposable pipette tip therefrom once it has been positioned downwardly therethrough. It is to be appreciated that an engagement member 126 in accordance with the present invention may comprise any of a number of other structural configurations in accordance with the spirit and intent of the present invention. As one example, an engagement member 126 may simply comprise a bump or a tab or a ridge positioned in one or both of an upper engagement channel 122 or a lower engagement channel 124, just to name a few.

As best shown in FIG. 3, the sample tube filtration system 100 includes a wiper assembly 130. In the preferred embodiment, this wiper assembly is a single solid membrane made of silicone. It features a central slit 131 with a width of 3 mm. The wiper assembly is designed to engage with the inner walls of a sample tube, preventing suspended particulate matter from bypassing the sample tube filter assembly 110 when the assembly is moved inside the tube. Additionally, similar to the filter top 111 and the filter bottom 113 (as shown in FIGS. 1 and 2) the wiper assembly 130 includes a plurality of four holes 133 configured to accept the four posts 123 extending from the filter bottom 113. These holes 133 secure the wiper assembly 130 in place, ensuring it maintains a seal against the inner walls of the sample tube during operation. The central slit 131 allows for the insertion of a disposable pipette tip while preventing bypass of suspended particulate matter.

The illustrative embodiments in FIGS. 8 and 9 show how the wiper assembly 130 establishes a seal with the inner walls of the sample tube. This seal ensures that suspended particulate matter does not bypass the filter system. The silicone material and design of the wiper assembly provide the necessary flexibility for it to maintain the seal during both insertion and removal from the sample tube. More particularly, the wiper assembly 130 are formed of a resilient material of construction to facilitate forming multiple seals around and along the inner walls IW of a sample tube ST, once again, so as to minimize and/or prevent suspended particulate matter SP from bypassing a sample tube filter assembly 110 when the sample tube filter assembly 110 is pushed downward through a portion of the liquid sample LS in the sample tube ST, as is shown best in the illustrative embodiments of FIGS. 8 and 9. As will be further appreciated from FIG. 8, an outer diameter of a sample tube filter assembly 110 must be slightly less than an inner diameter ID of a sample tube ST in which it is to be inserted, however, the wiper assembly 130 extends outwardly from the outer periphery of the filter top 111 and filter bottom 113, respectively, the overall diameter of the entire sample tube filter system 100 is greater than the inner diameter ID of the sample tube ST. However, by virtue of the resilient construction of the wiper assembly 130, the sample tube filter assembly 110 may be pushed downwardly into and pulled upwardly out of the sample tube ST, while the wiper assembly 130 maintains contact with the inner walls of the sample tube in each direction.

Now that a sample tube filtration system 100 in accordance with the present invention has been disclosed and described, a method of filtering a liquid sample in a sample tube with a sample tube filtration system and obtaining a liquid sample therefrom, shall be presented.

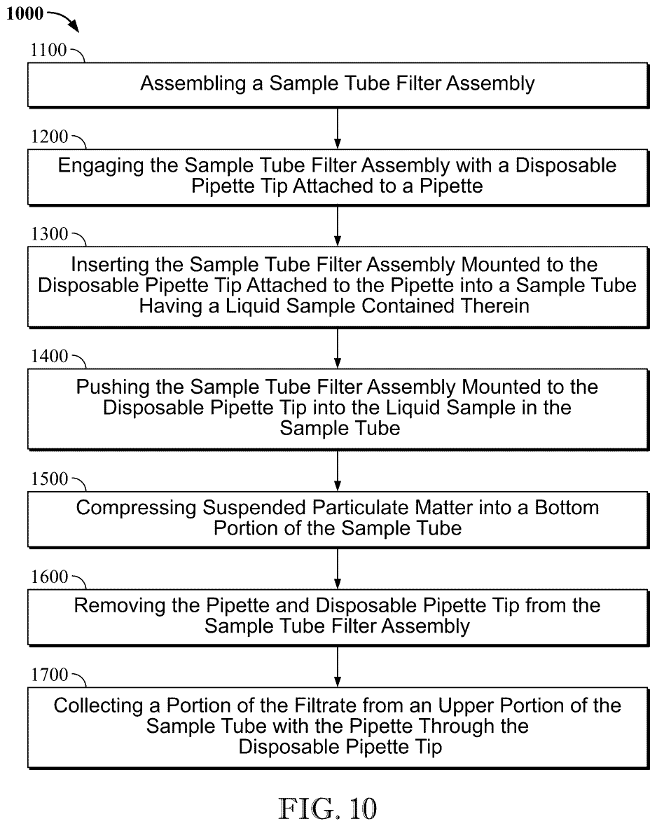

Beginning with FIG. 10, presented therein is a diagrammatic representation of one illustrative embodiment of a method of filtering a liquid sample in a sample tube with a sample tube filtration system, generally as shown as at 1000, and obtaining a liquid sample therefrom, in accordance with the present invention. The present method 1000 includes assembling a sample tube filter assembly 1100, for example, as is shown in FIGS. 1 and 2. The present method 1000 also includes engaging the sample tube filter assembly with a disposable pipette tip attached to a pipette 1200, such as is shown in FIG. 5. It is to be appreciated that the depictions of a disposable pipette tips DP shown throughout the figures are for reference only and that actual disposable pipette tips may comprise any of a number of actual configurations, depending on the size of the pipette to which it is to be attached, as well as the size and configuration of the liquid sample tube in which it is to be inserted. As just one example, an actual disposable pipette tip may comprise a considerably more elongated configuration than is shown in the figures, such that a sample tube filter assembly will be positioned about one-quarter to about one-third of the length from the bottom of the disposable pipette tip when mounted thereon.

With reference next to the illustrative embodiment of FIGS. 6A through 6C, the present method of filtering a liquid sample in a sample tube with a sample tube filtration system 1000 includes inserting the sample tube filter assembly mounted to a disposable pipette tip PT attached to a pipette P into a sample tube ST having a liquid sample LS contained therein 1300. As shown in FIGS. 6A through 6C, the present method 1000 also includes pushing the sample tube filter assembly mounted to the disposable pipette tip PT into the liquid sample LS in the sample tube ST 1400, as is shown best in FIG. 6A. As will be appreciated, the actual level of the liquid sample in the sample tube may vary depending on the type of liquid sample, and although shown in the figures as nearly full, in actual operation, the level of the liquid sample in the sample tube may range from about one-half to about three-quarters full in the sample tube, such that the disposable pipette tip PT is never fully submerged in the liquid sample LS. Next, the present method 1000 includes compressing the suspended particulate matter SP into the bottom portion of the sample tube ST 1500, as is shown in FIG. 6B. Typically, in actual operation, the suspended particulate matter will be compressed into the bottom portion of the sample tube to about one-quarter to about one-third of the distance from the bottom of the sample tube.

The present method of filtering a liquid sample in a sample tube with a sample tube filtration system 1000 further comprises removing the pipette P and disposable pipette tip PT from the sample tube filter assembly 1600, which remains in the lower portion of the example tube, as is shown in FIG. 6C, and collecting a portion of the filtered liquid sample SP, or filtrate, with the pipette P through the disposable pipette tip PT 1700, as also shown in FIG. 6C.

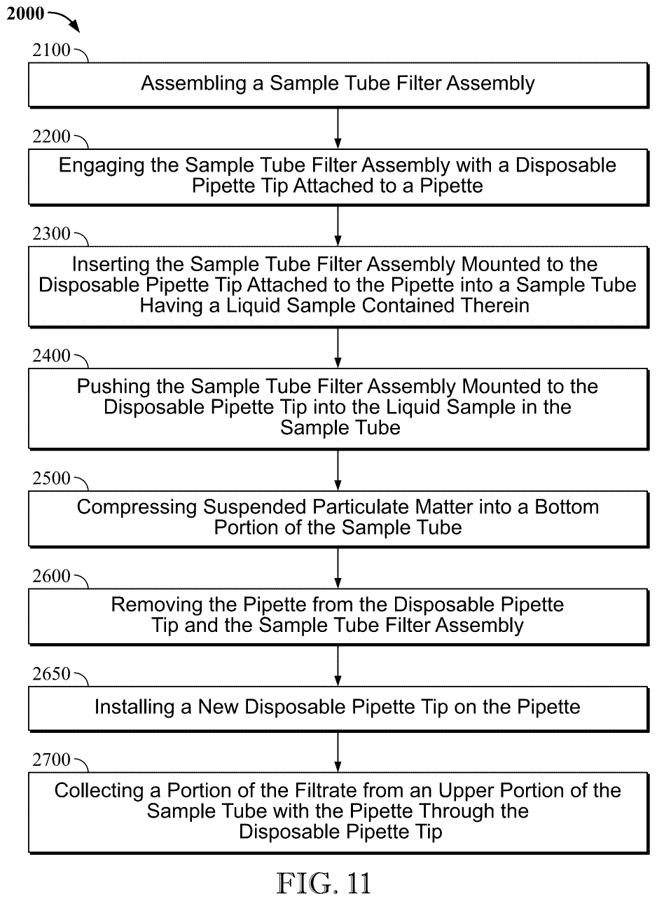

Looking next to FIG. 11, presented therein is a diagrammatic representation of one alternative illustrative embodiment of a method of filtering a liquid sample in a sample tube with a sample tube filtration system, generally as shown as at 2000, and obtaining a liquid sample therefrom, in accordance with the present invention. The alternative method 2000 includes assembling a sample tube filter assembly 2100, once again, as is shown in FIGS. 1 and 2. The alternative method 2000 also includes engaging the sample tube filter assembly with a disposable pipette tip attached to a pipette 2200, such as is shown in FIG. 5. As before, it is to be appreciated that the depictions of a disposable pipette tips DP shown throughout the figures are for reference purposes only and that actual disposable pipette tips may comprise any of a number of actual configurations, depending on the size of the pipette to which it is to be attached, as well as the size and configuration of the liquid sample tube in which it is to be inserted. Also as before, and as just one example, an actual disposable pipette tip may comprise a considerably more elongated confirmation that shown in the figures, such that a sample tube filter assembly will be positioned about one-quarter to about one-third of the length from the bottom of the disposable pipette tip.

With reference next to the illustrative embodiment of FIGS. 7A through 7D, the alternative method of filtering a liquid sample in a sample tube with a sample tube filtration system 2000 also includes inserting the sample tube filter assembly mounted to a disposable pipette tip DP attached to a pipette P into a sample tube ST having a liquid sample LS contained therein 2300. As shown in FIGS. 7A through 7D, the alternative method 2000 also includes pushing the sample tube filter assembly mounted to the disposable pipette tip DP into the liquid sample LS in the sample tube ST 2400, as is shown best in FIG. 7A. As before, it will be appreciated that the actual level of the liquid sample tube may vary depending on the type of liquid sample, and although shown in the figures as nearly full, in actual operation, the level of the liquid sample may range from about one-half to about three-quarters full in the sample tube, once again, such that the disposable pipette tip PT is never fully submerged in the liquid sample LS. Next, the alternative method 2000 includes compressing the suspended particulate matter SP into the bottom portion of the sample tube ST 2500 as is shown in FIG. 7B. Once again, in actual operation, the suspended particulate matter SP will be compressed into the bottom portion of the sample tube to about one-quarter to about one-third of the distance from the bottom of the sample tube.

The alternative method of filtering a liquid sample in a sample tube with a sample tube filtration system 2000 further comprises removing the pipette P from the disposable pipette tip PT 2600, which remains in the lower portion of the sample tube ST with the sample tube filter assembly mounted thereto, as is shown in FIG. 7C. Next, the alternative method 2000 includes installing a new disposable pipette tip onto the pipette 2650, and, finally, the alternative method 2000 includes collecting a portion of the filtered liquid sample SP, or filtrate, with the pipette P through the new disposable pipette tip DP 2700, as is shown best in FIG. 7D.

It is to be appreciated that a sample tube filtration system 100 in accordance with the present invention may be utilized with any type of liquid sampling protocols, including individual sample tube sampling, multiple sample tube sampling, as well as automated pipetting systems performing simultaneous liquid sampling from a large number of liquid sample tubes on a continuous or near continuous basis.

It is also to be appreciated that the present methods of filtering a liquid sample in a sample tube with a sample tube filtration system 1000, 2000 may also be implemented with any type of liquid sampling protocols, including individual sample tube sampling, multiple sample tube sampling, as well as automated pipetting systems performing simultaneous liquid sampling from a large number of liquid sample tubes on a continuous or near continuous basis.

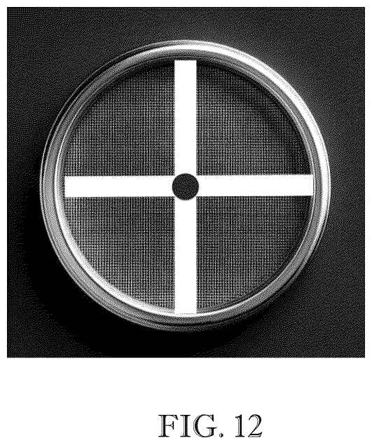

In another implementation of the present invention, the assembly may be used for solid phase extraction (SPE), incorporating a novel approach where the SPE material is bonded directly to a support structure, such as the wire mesh configuration depicted in FIG. 12, to enable targeted analyte isolation within the sample tube itself. Unlike traditional SPE systems that require external pressure or vacuum equipment to pass liquid through packed columns or cartridges, this implementation integrates the SPE material into the filtration assembly, allowing analyte adsorption to occur dynamically as the assembly is moved through the liquid sample. This innovative design, exemplified by the wire mesh embodiment of FIG. 12, eliminates the need for additional equipment and streamlines the workflow, making the system highly efficient for applications in chemical analysis, pharmaceutical development, and environmental testing.

In another embodiment, the sample tube filtration system includes an alternative configuration wherein the filter assembly comprises a tubular body instead of a flat wire mesh support structure. As illustrated in FIGS. 8 and 9, the tubular body provides additional surface area for SPE material bonding, significantly increasing the system's capacity to adsorb analytes of interest. Specifically, the tubular body includes both an inner surface and an outer surface, each chemically bonded with the SPE material. This dual-surface configuration maximizes the total surface area available for interaction with the liquid sample, improving analyte retention efficiency.

The tubular body further comprises an upper attachment section, dimensioned and configured to securely engage a portion of a disposable pipette tip, as previously described for the flat wire mesh embodiments. In one embodiment, the upper attachment section features an engagement channel, similar to the engagement channels 122 and 124 in FIG. 1, allowing the tubular body to be mounted and operated by a pipette and pipette tip. The tubular body may be pushed downward and moved repeatedly through the liquid sample, facilitating both mechanical separation of suspended particulates and selective chemical adsorption of analytes onto the SPE material.

In this implementation, the tubular body is particularly suited for applications requiring the filtration and extraction of small sample volumes, such as those processed in microtubes, small wells, or narrow-diameter containers. The tubular body can be fabricated in various lengths and diameters depending on the desired application. For example, longer tubular bodies allow for an increased quantity of SPE material to be bonded to the surface, thereby enhancing the system's capacity to capture analytes of interest from larger or more concentrated liquid samples. The diameter of the tubular body is designed to allow insertion into small sample tubes or wells without impeding fluid flow, ensuring compatibility with both manual and automated liquid handling systems.

The tubular body itself may be constructed from stainless steel or other rigid materials capable of supporting the SPE material while withstanding repeated plunging motions through a liquid sample. The stainless steel construction provides durability, chemical resistance, and structural integrity, ensuring the system's reliability across multiple uses. The SPE material bonded to the tubular body can include a range of chemically modified surfaces tailored to the specific analytes being targeted. Examples of such materials include silica, modified silica, polymers, or metal oxides, each selected for their affinity to certain chemical groups or compounds.

As with the previously described embodiments, the system may include a wiper assembly 130, as shown in FIG. 3. In this configuration, the wiper assembly is disposed around the outer surface of the tubular body to engage the inner wall of a sample tube or well. The wiper assembly, formed of a resilient material such as silicone, creates a seal that prevents the bypass of liquid sample around the tubular body. This ensures that the liquid is directed through the SPE material on the tubular body, improving both particulate filtration and analyte adsorption efficiency. The wiper assembly may include a central slit 131 to accommodate the engagement of the disposable pipette tip with the tubular body while maintaining the seal.

In operation, the tubular body functions similarly to the flat wire mesh embodiment described in FIGS. 6A through 6C and FIGS. 7A through 7D. The system is assembled by engaging the tubular body with a disposable pipette tip attached to a pipette. The tubular body is then inserted into a liquid sample within a small sample tube or well. Using the pipette, the tubular body is pushed downward and repeatedly moved through the liquid sample, causing the SPE material to adsorb analytes of interest while simultaneously compressing suspended particulate matter toward the bottom of the sample container.

To wash the tubular body, the pipette may be removed, and the tubular body can be gently plunged up and down in a small volume of a wash solvent, such as water or a buffer. This washing step removes interferences or contaminants trapped on the SPE material while leaving the target analytes retained on the chemically bonded surface. Once the analytes have been isolated, the tubular body is transferred to a shallow tube containing a small amount of solvent. Repeated plunging of the tubular body through the solvent releases the adsorbed analytes into the liquid, enabling their recovery in a concentrated form for downstream analysis.

The tubular configuration of the SPE system offers several advantages over conventional flat filter designs. First, the increased surface area of the inner and outer surfaces enhances analyte capture efficiency without significantly increasing the device's footprint. Second, the ability to customize the tubular body's length and diameter provides flexibility for a wide range of sample processing applications, including microfluidic systems, automated platforms, and manual workflows. Third, the tubular body's durability and chemical resistance make it suitable for repeated use in high-throughput or harsh chemical environments.

In addition, the tubular body design enables the filtration and analyte isolation of very small sample volumes, addressing a critical need in applications requiring high sensitivity and accuracy. The system's compatibility with standard pipette tips and pipette-based workflows ensures seamless integration into existing laboratory protocols, eliminating the need for complex or specialized equipment.

The dual-surface bonding of SPE material to both the inner and outer surfaces of the tubular body represents a significant advancement in solid phase extraction technology. By allowing simultaneous exposure of the liquid sample to both surfaces during the plunging process, the system achieves higher adsorption efficiency and faster analyte recovery compared to traditional SPE methods. Moreover, the tubular configuration reduces the risk of sample clogging or bypass, ensuring consistent and reliable performance across a variety of sample types.

Overall, the tubular body implementation of the present invention provides an efficient, versatile, and cost-effective solution for the simultaneous filtration and isolation of analytes from liquid samples. The design's adaptability to small sample tubes, microtubes, or wells, combined with its enhanced adsorption capacity and operational simplicity, makes it particularly well-suited for laboratories seeking to improve the efficiency and accuracy of their sample preparation workflows.

This implementation further emphasizes the versatility of the present invention, as the system can be configured for use with either flat wire mesh supports or tubular bodies, depending on the specific application requirements. Both configurations utilize the same fundamental principles of pipette-based engagement, repeated movement through the sample, and chemically bonded SPE material for analyte isolation. By offering multiple configurations, the present invention provides a flexible solution to meet the diverse needs of modern laboratories handling liquid sample processing.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A sample tube filtration system for filtering a liquid sample in a sample tube and isolating analytes of interest therein, wherein the liquid sample includes suspended particulate matter, for use with a pipette having a disposable pipette tip attached thereto, said system comprising:
a sample tube filter assembly comprising a support structure configured to retain a chemically bonded solid phase extraction (SPE) material, said support structure allowing liquid to pass therethrough while selectively adsorbing analytes of interest from the liquid sample; and
a pipette tip engagement assembly dimensioned and configured to operatively engage a portion of the disposable pipette tip so that said sample tube filter assembly is mountable to a portion of the disposable pipette tip, such that said sample tube filter assembly may be pushed downward through and repeatedly moved within at least a portion of the liquid sample in the sample tube by the disposable pipette tip attached to the pipette.

2. The system of claim 1, wherein said support structure comprises a wire mesh having a plurality of openings configured to allow liquid flow therethrough while supporting said solid phase extraction (SPE) material.

3. The system of claim 2, wherein said wire mesh support structure comprises a chemically bonded SPE material selected to selectively retain analytes of a predetermined chemical property.

4. The system of claim 1, wherein said sample tube filter assembly includes an alternative configuration comprising a tubular body having a length, said tubular body comprising an outer surface and an inner surface, wherein said solid phase extraction (SPE) material is bonded to both said inner surface and said outer surface.

5. The system of claim 4, wherein said tubular body includes an upper attachment section configured to engage a portion of the disposable pipette tip for operation of said tubular body within the liquid sample.

6. The system of claim 4, wherein said tubular body comprises a diameter sized for insertion into a small sample tube or well.

7. The system of claim 4, wherein said tubular body has a length configured to increase the surface area available for bonding of said solid phase extraction (SPE) material.

8. The system of claim 2, further comprising an upper body and a lower body interconnected to enclose said wire mesh support structure, wherein said upper body and lower body secure said solid phase extraction (SPE) material in position.

9. The system of claim 8, wherein said pipette tip engagement assembly includes an upper engagement channel formed through a portion of said upper body and a lower engagement channel formed through a portion of said lower body.

10. The system of claim 9, wherein said upper engagement channel and said lower engagement channel are disposed coaxially with one another.

11. The system of claim 2, wherein said wire mesh support structure is constructed from stainless steel.

12. The system of claim 4, wherein said tubular body is constructed from stainless steel.

13. The system of claim 1, wherein said solid phase extraction (SPE) material comprises a chemically modified surface configured to adsorb analytes of interest from the liquid sample.

14. The system of claim 1, wherein said system is configured to allow repeated movement of said sample tube filter assembly through the liquid sample to enhance adsorption of analytes onto said solid phase extraction (SPE) material.

15. The system of claim 4, wherein said tubular body is configured to enhance analyte retention by providing increased solid phase extraction (SPE) surface area relative to a flat support structure.

16. The system of claim 8, further comprising a wiper assembly disposed around at least one of said upper body and said lower body, said wiper assembly configured to engage an inner wall of the sample tube to minimize bypass of the liquid sample around said sample tube filter assembly.

17. The system of claim 1, wherein said solid phase extraction (SPE) material is configured to release adsorbed analytes into a solvent upon contact with the solvent.

18. The system of claim 1, wherein said system is configured to enable washing of said solid phase extraction (SPE) material with a solvent to remove interferences while retaining analytes of interest.

19. A sample tube filtration system for isolating analytes of interest from a liquid sample in a sample tube, wherein the liquid sample includes suspended particulate matter, for use with a pipette having a disposable pipette tip attached thereto, said system comprising:
a sample tube filter assembly having an upper body and a lower body interconnected to one another;
a wire mesh support structure disposed between said upper body and said lower body, said wire mesh support structure comprising a chemically bonded solid phase extraction (SPE) material configured to selectively adsorb analytes of interest from the liquid sample while allowing liquid to pass therethrough; and
a pipette tip engagement assembly dimensioned and configured to operatively engage a portion of the disposable pipette tip so that said sample tube filter assembly is mountable to a portion of the disposable pipette tip, such that said sample tube filter assembly may be pushed downward through and repeatedly moved within at least a portion of the liquid sample in the sample tube by the disposable pipette tip attached to the pipette.

20. A sample tube filtration system for isolating analytes of interest from a liquid sample in a small sample tube or well, wherein the liquid sample includes suspended particulate matter, for use with a pipette having a disposable pipette tip attached thereto, said system comprising:
a tubular body having a length and a diameter sized for insertion into the small sample tube or well, said tubular body comprising an inner surface and an outer surface, wherein a solid phase extraction (SPE) material is chemically bonded to both said inner surface and said outer surface;
an upper attachment section configured to engage a portion of the disposable pipette tip to allow for operation of said tubular body within the liquid sample;
a wiper assembly disposed around said tubular body, said wiper assembly comprising a resilient material configured to engage an inner wall of the small sample tube or well to minimize bypass of the liquid sample around said tubular body; wherein
said tubular body is configured to allow repeated plunging motions through the liquid sample to enhance adsorption of analytes onto said solid phase extraction (SPE) material; and further; wherein
said solid phase extraction (SPE) material is configured to selectively retain analytes of interest and to release said analytes into a solvent upon contact with the solvent.
